(19) United States
(12) Patent Application Publication
(10) Pub. No.: US 2008/0129771 A1
(43) Pub. Date: Jun. 5, 2008

(54) APPARATUS AND METHOD OF DRIVING PIEZOELECTRIC INKJET PRINTHEAD

(75) Inventor: Woo-sik KIM, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/776,582

(22) Filed: Jul. 12, 2007

(30) Foreign Application Priority Data
Dec. 1, 2006 (KR) 2006-120956

(51) Int. Cl. B41J 29/38

(52) U.S. Cl. 347/11

(57) ABSTRACT

A driving apparatus and method of a piezoelectric inkjet printhead includes applying an auxiliary pulse to neutralize a pressure wave remaining in a pressure chamber after ejecting ink, the auxiliary pulse being applied between a plurality of driving pulses applied to a piezoelectric actuator for ejecting ink. Accordingly, the remaining pressure wave is neutralized by applying the auxiliary pulse after applying a driving pulse, thereby securing stable ink ejection of the inkjet printhead.

### CROSS-REFERENCE TO RELATED APPLICATIONS

This application claims the benefit of Korean Patent Application No. 10-2006-0120956, filed on Dec. 1, 2006 in the Korean Intellectual Property Office, the disclosure of which is incorporated herein in its entirety by reference.

### BACKGROUND OF THE INVENTION

1. Field of the Invention

The present general inventive concept relates to an apparatus and method of driving an inkjet printhead to eject ink in a piezoelectric mode, and more particularly, to an apparatus and method of driving an inkjet printhead capable of neutralizing one or more pressure waves remaining in a pressure chamber after ink is ejected by a driving pulse.

2. Description of the Related Art

An inkjet printhead is an apparatus that ejects minute droplets of printing ink on desired positions of recording medium in order to print predetermined color images. Inkjet printers include inkjet printheads for ejecting ink. Inkjet printheads are categorized into two types according to the ink ejection mechanism thereof. The first one is a thermal inkjet printhead that ejects ink due to an expansion force of bubbles generated in ink by thermal energy. The other one is a piezoelectric inkjet printhead that ejects ink droplets by pressure applied to ink due to the deformation of a piezoelectric body.

In a piezoelectric inkjet printhead, when a driving pulse is applied to a piezoelectric actuator, a piezoelectric body is deformed and a diaphragm on one wall of a pressure chamber is vibrated. Here, ink is ejected via a nozzle by a pressure wave generated in the pressure chamber. After ejecting ink, the pressure wave dissipates by a damped oscillation. When the pressure wave does not completely disappear or does not dissipate to a certain amount or less, it may affect next ink ejection, and ejecting a proper amount of ink at a proper speed may become difficult. That is, when a remaining pressure wave offsets a new pressure wave generated by a next driving pulse, ink may not be ejected, the amount of ejected ink may be decreased or the ejection speed may be lowered. Also, when the remaining pressure wave amplifies the new pressure wave generated by the new driving pulse, the amount of ink or the speed of ink ejection may become excessive. In detail, when a driving pulse of about 5 KHz or greater is applied to perform high speed printing, the influence of such a remaining pressure wave on a new pressure wave may be great.

### SUMMARY OF THE INVENTION

The present general inventive concept provides a apparatus and method of driving a piezoelectric inkjet printhead that is capable of neutralizing one or more remaining pressure waves.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of driving a piezoelectric inkjet printhead comprising a pressure chamber and a piezoelectric actuator to provide a driving force to the pressure chamber for ink ejection, the method including applying an auxiliary pulse to neutralize a pressure wave remaining in the pressure chamber after ejecting ink, wherein the auxiliary pulse is applied between a plurality of driving pulses applied to the piezoelectric actuator to eject ink.

When an effective length of the pressure chamber is L and the transmission speed of the pressure wave in the ink is C, an auxiliary pulse having the same polarity as the driving pulse may be applied a time (4n+2) L/C after the driving pulse has been applied, and an auxiliary pulse having the opposite polarity to the driving pulse may be applied a time 4n L/C after the driving pulse has been applied. The voltage of the auxiliary pulse may be lower than the voltage of the driving pulse.

When applying the auxiliary pulse a time 2L/C after the driving pulse has been applied, the voltage of the auxiliary pulse may be about 45-65% of the voltage of the driving pulse.

When applying the auxiliary pulse a time 4L/C after the driving pulse has been applied, the voltage of the auxiliary pulse may be about 20-42% of the voltage of the driving pulse.

The foregoing and/or other aspects and utilities of the present general inventive concept may also be achieved by providing a method of driving a piezoelectric inkjet printhead, the method including generating a driving signal to generate a pressure wave in a pressure chamber to eject ink, and generating an auxiliary signal to neutralize a remaining wave of the pressure wave in the pressure chamber.

The generating the auxiliary signal may include generating the auxiliary signal according to a transmission speed of the pressure wave and a length of the pressure chamber.

The generating of the auxiliary signal may include generating an auxiliary wave to offset the remaining wave in the pressure chamber.

The auxiliary wave may not eject the ink from the pressure chamber.

The auxiliary wave may have a phase opposite to the remaining wave.

The auxiliary wave may have one of a first phase opposite to the pressure wave and a second phase which is the same as the pressure wave.

The pressure wave may be changed to the remaining wave when the ink is ejected by the pressure wave.

The auxiliary signal may be different from the driving signal in a time period and amplitude.

The foregoing and/or other aspects and utilities of the present general inventive concept may also be achieved by providing a method of driving an inkjet printhead of an image forming apparatus, the method including generating a first driving signal to generate a first pressure wave in a pressure chamber to eject ink, and a second driving signal to generate a second pressure wave in the pressure chamber to eject ink, and generating an auxiliary signal between the first and second driving signals according to a transmission speed of the first pressure wave and a length of the pressure chamber to neutralize a remaining wave of the pressure wave.

The foregoing and/or other aspects and utilities of the present general inventive concept may also be achieved by providing an image forming apparatus including a piezoelectric inkjet printhead having a manifold, an actuator, and a pressure chamber with a nozzle, and a controller to generate a driving signal to the actuator to generate a pressure wave in a pressure chamber to eject ink from the pressure chamber through the nozzle, and to generate an auxiliary signal to neutralize a remaining wave of the pressure wave in the pressure chamber.

The controller may generate the auxiliary signal according to a transmission speed of the pressure wave and a length of the pressure chamber.

The controller may generate the auxiliary signal to generate an auxiliary wave having an opposite phase to the remaining wave according to a transmission speed of the pressure wave and a length of the pressure chamber.

The controller may generate a second driving signal to the actuator to generate a second pressure wave in the pressure chamber to eject a second ink after the auxiliary signal is applied to the actuator to offset the remaining wave.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a cross-sectional view illustrating a piezoelectric inkjet printhead usable in an image forming apparatus to perform a method of driving a piezoelectric inkjet printhead according to an embodiment of the present general inventive concept;

FIG. 2 illustrates a driving pulse and an auxiliary pulse of the method of driving a piezoelectric inkjet printhead according to an embodiment of the present general inventive concept;

FIG. 3 illustrates movement of a pressure wave in a pressure chamber;

FIG. 4 illustrates an experiment to determine a voltage of an auxiliary pulse when a delay time is set as 2L/C according to an embodiment of the present general inventive concept; and

FIG. 5 illustrates an experiment to determine a voltage of an auxiliary pulse when a delay time is set as 4L/C according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 1 is a cross-sectional view illustrating a piezoelectric inkjet printhead usable with an image forming apparatus which a driving method of a piezoelectric inkjet printhead is applied, according to an embodiment of the present general inventive concept. The image forming apparatus may include a medium feeding unit (not illustrated) to feed a printing medium disposed to receive ink ejected from the piezoelectric inkjet printhead to form an image thereon. The image forming apparatus may include conventional components to generate data, to control the printing medium, and to form the image on the printing medium according to the data. The conventional components are well known, and thus detail descriptions thereof will be omitted.

Referring to FIG. 1, the piezoelectric inkjet printhead includes a substrate 110 in which an ink passage is formed, and a piezoelectric actuator 140 providing ink ejection pressure. The substrate 110 includes a pressure chamber 111 and a manifold 113 to supply ink to the pressure chamber 111. A nozzle substrate 120, in which a nozzle 122 connected in line with the pressure chamber 111 is formed, is bonded to the substrate 110 in which the ink passage is formed. A diaphragm 114 is vibrated by the piezoelectric actuator 140, and the diaphragm 114 forms a wall of the pressure chamber 111 in the present embodiment.

The piezoelectric actuator 140 vibrates the diaphragm 114 to provide a driving force to the pressure chamber 111 to eject ink. The piezoelectric actuator 140 includes a common electrode 141, a piezoelectric layer 142 that is deformed according to the application of a voltage, and a driving electrode 143 to which a driving voltage is applied.

If the substrate 110 is formed of a silicon wafer, an insulating layer (not shown) is formed between the piezoelectric actuator 140 and the substrate 110. The insulating layer may be, for example, a silicon oxide layer formed using a plasma chemical vapor deposition (PECVD) method on the substrate 110.

The piezoelectric layer 142 can be formed by coating a piezoelectric material in a paste form on the insulating layer to a predetermined thickness, and then, sintering the coated piezoelectric material. The piezoelectric layer 142 is formed to correspond to the pressure chamber 111. Various piezoelectric materials can be used for the piezoelectric layer 142; preferably, lead zirconate titanate (PZT) ceramic may be used.

The common electrode 141 and the driving electrode 143 are formed of a conductive metal, and the common electrode 141 and the driving electrode 143 may be formed of one metal layer or two metal layers, such as a Ti layer and a Pt layer. The common electrode 141 and the driving electrode 143 may respectively be formed by depositing Ti and Pt on the surface of the insulating layer and the piezoelectric layer 142 to a predetermined thickness using a sputtering method. Also, the common electrode 141 and the driving electrode 143 may be formed of a conductive metal on the isolation layer and the piezoelectric layer 142, for example, by screen-printing Ag—Pd paste. If the common electrode 141 and the driving electrode 143 are formed by screen-printing Ag—Pd paste, the piezoelectric layer 142, the common electrode 141, and the driving electrode 143 are sintered at a predetermined temperature, for example, in the range of 900 to 1000° C. Afterwards, a poling process is performed by applying an electric field to the piezoelectric layer 142 in order to generate piezoelectric characteristics of the piezoelectric layer 142, and the piezoelectric layer 142 can be also formed by attaching a bulk piezolelectric material on the insulating layer.

Reference numeral 150 denotes a pulse applying unit as a controller to generate or apply a driving pulse (driving signal) to a driving electrode 143. When the driving pulse is applied to the driving electrode 143, the piezoelectric layer 142 is deformed and the diaphragm 114 is bent to apply a positive pressure to the ink in the pressure chamber 111. Then ink is ejected through a nozzle 122 by this pressure. After ink ejection is completed and until a next driving pulse is applied, a remaining pressure wave dissipates by a damped oscillation in the pressure chamber 111.

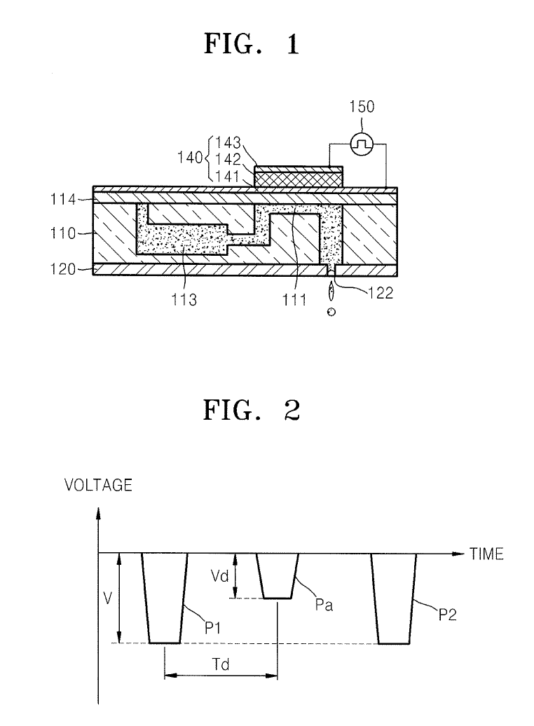

FIG. 2 illustrates a driving pulse and an auxiliary pulse of the method of driving a piezoelectric inkjet printhead according to an embodiment of the present general inventive concept. As illustrated in FIGS. 1 and 2, according to the present embodiment, a plurality of driving pulses P1 and P2 are applied to eject ink to form an image, and an auxiliary pulse Pa is applied between the plurality of driving pulses P1 and P2 in order to neutralize a remaining pressure wave generated by the driving pulse P1. Thus the remaining pressure wave in the pressure chamber 111 is quickly neutralized by the auxiliary pulse Pa after ink ejection, and a pressure wave of a desired size can be formed in the pressure chamber 111 by a next driving pulse P2. The auxiliary pulse Pa is applied a period of time after the driving pulse P1 is applied. Since the auxiliary pulse Pa is applied a predetermined delay time Td after the driving pulse P1 is applied, the size of the remaining pressure wave during the delay time Td is smaller than an initial pressure wave generated by the driving pulse P1. Accordingly, a voltage Va of the auxiliary pulse Pa may be smaller than a voltage V of the driving pulses P1 and P2. As described above, the remaining pressure wave in the pressure chamber 111 is neutralized by applying the auxiliary pulse Pa after applying the driving pulse P1, and thus ink droplets having a uniform size can be stably ejected at a proper speed. Also, the frequency of applying the driving pulse P1 can be increased, and thus high speed driving at 5 KHz or greater is possible.

A time period during which the auxiliary pulse Pa is applied to the piezoelectric actuator 140 may be equal to a time period of the driving pulse P1 or P2, and amplitude of the auxiliary pulse Pa may be smaller than the driving pulse P1 or P2. It is also possible that the item period of the auxiliary pulse Pa may be shorter or greater than the driving pulse P1 or P2.

Hereinafter, a method of setting a delay time Td and a method of determining a voltage Va of an auxiliary pulse Pa will be described.

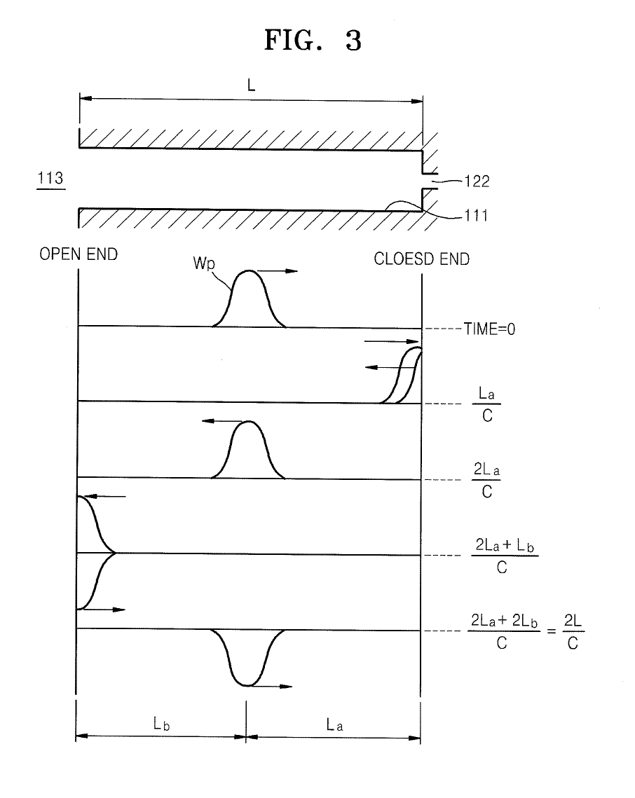

FIG. 3 illustrates movement of a general pressure wave in the pressure chamber 111 of FIG. 1. Referring to FIGS. 1, 2, and 3, the pressure chamber 111 may be a chamber having an effective length L with an end connected to the manifold 113 and another end connected to the nozzle 122. The end connected to the manifold 113 may be referred to as an open end, and the end connected to the nozzle 122 may be referred to as a closed end. In FIG. 3, C denotes the transmission speed of a pressure wave, which is identical to the speed of sound in the ink.

Here, the behavior of a general pressure wave Wp in the pressure chamber 11 illustrated in FIG. 3 will be described. At time zero 0, the pressure wave Wp is moving toward the nozzle 122 at the speed of C and positioned at the point whose distance to the nozzle 12 is La and distance to the manifold 113 is Lb. After a time La/C has passed, the pressure wave Wp arrives at the nozzle 122. The nozzle 122 is a closed end and thus the pressure wave Wp is reflected without change in phase. Accordingly, the phase of the pressure wave Wp after a time 2La/C has passed is identical to the phase of the pressure wave at time “0,” and the pressure wave Wp moves in a reverse direction. When a time (2La+Lb)/C has passed, the pressure wave Wp is incident on the manifold 113. The manifold 113 is an open end and thus the pressure wave Wp is reflected, and the phase thereof is reversed. After a time 2L/C, the pressure wave Wp has the opposite phase to that at time “0” with the same moving direction. In the above explanation, although symmetric Gaussian shaped single wave is used, the above statement and explanation can be applied to any general shaped compound wave.

Accordingly, the phase of the pressure wave Wp is in a reversed state after a time interval of 2L/C, and an identical phase is repeated after a time interval of 4L/C. Accordingly, the remaining pressure wave can be neutralized by forming a wave having the same phase as the original pressure wave (i.e., when time=0) in the pressure chamber 111 when a delay time Td is set as (4n+2)L/C, or by forming a wave having the opposite phase to the original pressure wave in the pressure chamber 111 when a delay time Td is set as 4nL/C.

In the above descriptions, the recurring wave has no attenuation assuming that there are 100% reflections at the nozzle (the closed end) and the manifold (the open end). However, it is possible that attenuation may occur in a recurring wave during reflections. The voltage Va of the auxiliary pulse Pa may be defined in relation to a voltage Vp of the driving pulse P1. The size of the auxiliary voltage Pa may be determined by experimental analysis.

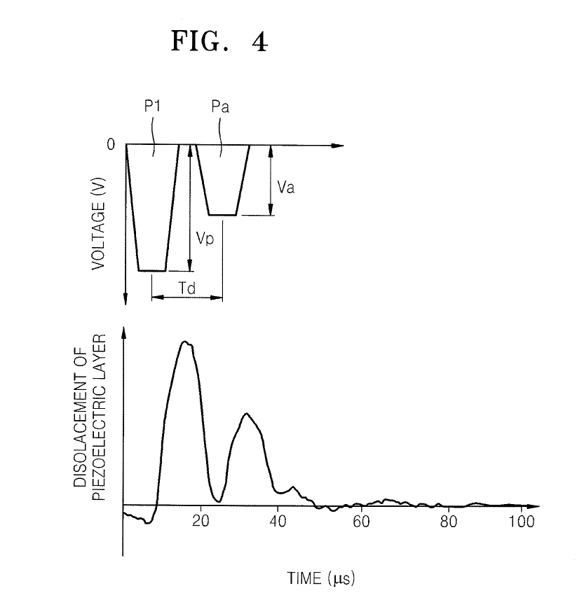

For example, FIG. 4 illustrates an experiment to determine a voltage Va of an auxiliary pulse Pa after a delay time 2L/C has passed when an auxiliary pulse Pa having the same polarity as the driving pulse P1 is applied. In this case, C was about 1200 m/s, and an effective length L of the pressure chamber 111 was about 10 mm. The voltage Vp of the driving pulse P1 was about −60 V. The experiment was performed while varying the voltage Va of the auxiliary pulse Pa after a delay time Td=2L/C=16.5 μs. To verify the effect, the displacement of the piezoelectric layer 142 was measured. As a result, the optimum effect was obtained when the voltage Va of the auxiliary pulse Pa was −33 V, which is about 55% of the voltage Vp of the driving pulse P1. According to the result of repeated experiments, when an auxiliary pulse Pa was applied after a delay time Td of 2L/C, a satisfactory effect was obtained when the voltage Va of the auxiliary pulse Pa was 45-65% of the voltage Vp of the driving pulse P1.

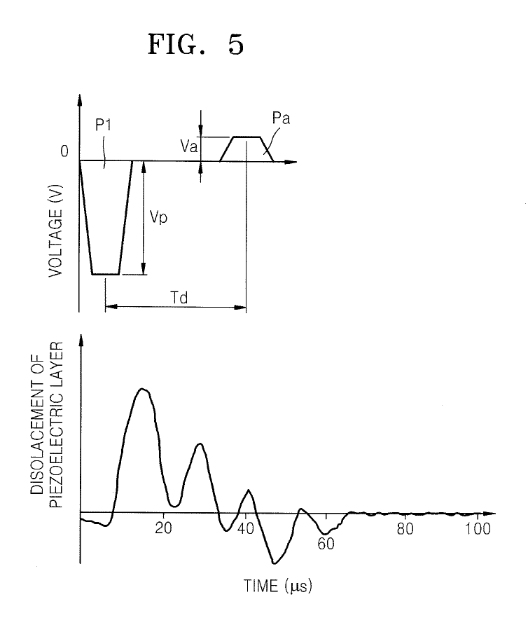

FIG. 5 illustrates an experiment to determine a voltage Va of an auxiliary pulse Pa after 4L/C when the auxiliary pulse Pa having the opposite polarity to the driving pulse P1 is employed. In this case, C was about 1200 m/s, and an effective length L of the pressure chamber 111 was about 10 mm. The voltage Vp of the driving pulse P1 was about −60 V. The experiment was performed while varying the voltage Va of the auxiliary pulse Pa after a delay time Td=4L/C=33 μs. To verify the effect, the displacement of the piezoelectric layer 142 was measured. As a result, the optimum effect was obtained when the voltage Va of the auxiliary pulse Pa was +18 V, which is about 30% of the voltage Vp of the driving pulse P1. Note that the twice of 55% attenuation gives 30% attenuation. According to the result of repeated experiments, when an auxiliary pulse Pa is applied after a delay time Td of 4L/C, a satisfactory effect was obtained when the voltage Va of the auxiliary pulse Pa was 20-42% of the voltage Vp of the driving pulse P1.

In the above described embodiment, a delay time Td was set as 2L/C or 4L/C. Here, it is possible that the above description may not represent an exact dimension of an inkjet head, such as the length L of the pressure chamber 111. It is also possible that the delay time Td may be determined experimentally.

When the auxiliary pulse Pa is applied to the piezoelectric actuator, the ink is not ejected since an auxiliary driving force or auxiliary pressure wave generated in the ink chamber by the auxiliary pulse Pa is smaller than a main driving force or main pressure wave of the main driving pulse P1 or P2 and is not enough to force ink to be ejected. That is, the driving force generated in the ink chamber by the auxiliary pulse Pa may offset a remaining driving force (wave) of the main driving force (wave) in the ink chamber. The generation of the auxiliary pulse Pa can be determined according to a transmission speed of the main pressure wave and a distance between the manifold and the nozzle, for example, a length of the ink chamber,

As described above, according to the driving method of the piezoelectric inkjet printhead according to the present general inventive concept, following effects can be obtained.

First, by applying an auxiliary pulse after applying a driving pulse, a remaining pressure wave is neutralized, thereby securing stable ink ejection of the inkjet printhead. In other words, ink droplets having a uniform size can be ejected at a proper speed.

Second, as the remaining pressure wave is quickly removed, the driving frequency of the inkjet printhead can be increased. Accordingly, high speed printing is possible.

According to the present general inventive concept, the above-describe apparatus and method can be applied to a thermal inkjet printer having one or more thermal inkjet printheads or a piezoelectric inkjet printer having one or more piezoelectric inkjet printheads.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of driving a piezoelectric inkjet printhead comprising a pressure chamber and a piezoelectric actuator to provide a driving force to the pressure chamber for ink ejection, the method comprising:
applying an auxiliary pulse to neutralize a pressure wave remaining in the pressure chamber after ejecting ink,
wherein the auxiliary pulse is applied between a plurality of driving pulses applied to the piezoelectric actuator to eject ink.

2. The method of claim 1, wherein, when an effective length of the pressure chamber is L and a transmission speed of the pressure wave in the ink is C, the auxiliary pulse is applied a time 2L/C after the driving pulse has been applied, and the voltage of the auxiliary pulse is about 45-65% of the voltage of the driving pulse.

3. The method of claim 1, wherein, when an effective length of the pressure chamber is L and a transmission speed of the pressure wave in the ink is C, the auxiliary pulse is applied a time 4L/C after the driving pulse has been applied, and a voltage of the auxiliary pulse is about 20-42% of the voltage of the driving pulse.

4. The method of claim 1, wherein, when an effective length of the pressure chamber is L and a transmission speed of the pressure wave in the ink is C, an auxiliary pulse having the same polarity as the driving pulse is applied a time (4n+2)L/C after the driving pulse has been applied, and an auxiliary pulse having the opposite polarity to the driving pulse is applied a time 4nL/C after the driving pulse has been applied.

5. The method of claim 4, wherein a voltage of the auxiliary pulse is lower than the voltage of the driving pulse.

6. The method of claim 4, wherein when applying the auxiliary pulse a time 2L/C after the driving pulse has been applied, a voltage of the auxiliary pulse is about 45-65% of the voltage of the driving pulse.

7. The method of claim 4, wherein when applying the auxiliary pulse a time 4L/C after the driving pulse has been applied, a voltage of the auxiliary pulse is about 20-42% of the voltage of the driving pulse.

8. A method of driving a piezoelectric inkjet printhead, the method comprising:
generating a driving signal to generate a pressure wave in a pressure chamber to eject ink; and
generating an auxiliary signal to neutralize a remaining wave of the pressure wave in the pressure chamber.

9. The method of claim 8, wherein the generating the auxiliary signal comprises generating the auxiliary signal according to a transmission speed of the pressure wave and a length of the pressure chamber.

10. The method of claim 8, wherein the generating of the auxiliary signal comprises generating an auxiliary wave to offset the remaining wave in the pressure chamber.

11. The method of claim 10, wherein the auxiliary wave do not eject the ink from the pressure chamber.

12. The method of claim 10, wherein the auxiliary wave has a phase opposite to the remaining wave.

13. The method of claim 10, wherein the auxiliary wave has one of a first phase opposite to the pressure wave and a second phase which is the same as the pressure wave.

14. The method of claim 8, wherein the pressure wave is changed to the remaining wave when the ink is ejected by the pressure wave.

15. The method of claim 8, wherein the auxiliary signal is different from the driving signal in a time period and amplitude.

16. A method of driving an inkjet printhead of an image forming apparatus, the method comprising:
generating a first driving signal to generate a first pressure wave in a pressure chamber to eject ink, and a second driving signal to generate a second pressure wave in the pressure chamber to eject ink; and
generating an auxiliary signal between the first and second driving signals according to a transmission speed of the first pressure wave and a length of the pressure chamber to neutralize a remaining wave of the pressure wave.

17. An image forming apparatus comprising:
a piezoelectric inkjet printhead having a manifold, an actuator, and a pressure chamber with a nozzle; and
a controller to generate a driving signal to the actuator to generate a pressure wave in a pressure chamber to eject ink from the pressure chamber through the nozzle, and to generate an auxiliary signal to neutralize a remaining wave of the pressure wave in the pressure chamber.

18. The apparatus of claim 17, wherein the controller generates the auxiliary signal according to a transmission speed of the pressure wave and a length of the pressure chamber.

19. The apparatus of claim 17, wherein the controller generates the auxiliary signal to generate an auxiliary wave having an opposite phase to the remaining wave according to a transmission speed of the pressure wave and a length of the pressure chamber.

20. The apparatus of claim 17, wherein the controller generates a second driving signal to the actuator to generate a second pressure wave in the pressure chamber to eject a second ink after the auxiliary signal is applied to the actuator to offset the remaining wave.
